(19) United States
(12) Patent Application Publication
(10) Pub. No.: US 2025/0124592 A1
(43) Pub. Date: Apr. 17, 2025

(54) APPARATUS AND METHOD FOR PARKING MANAGEMENT

(71) Applicant: SK Planet Co., Ltd., Seongnam-si (KR)

(72) Inventors: Yeong Hyeon PARK, Suwon-si (KR); Myung Jin KIM, Seongnam-si (KR)

(21) Appl. No.: 18/908,901

(22) Filed: Oct. 8, 2024

(30) Foreign Application Priority Data
Oct. 17, 2023 (KR) 10-2023-0138622
Oct. 18, 2023 (KR) 10-2023-0139716

(51) Int. Cl. G06T 7/70; G08G 1/16

(52) U.S. Cl. CPC G06T 7/70; G08G 1/168

(57) ABSTRACT

An apparatus and method for parking management are provided. In one example, parking management can be performed more accurately and efficiently by analyzing a planar image converted from an oblique image of a parking lot taken in an oblique shooting direction. In another example, parking management can be performed more accurately and efficiently by analyzing a corrected image obtained by correcting distortion due to lens aberration in a parking lot image.

### CROSS-REFERENCE TO RELATED APPLICATIONS

The present application is based upon and claims the benefit of priority to Korean Patent Application Nos. 10-2023-0138622, filed on Oct. 17, 2023, and 10-2023-0139716, filed on Oct. 18, 2023. The disclosures of the above-listed applications are herein incorporated by reference herein in their entirety.

### TECHNICAL FIELD

The present disclosure relates to parking management technology, and more particularly, to an apparatus and method for parking management based on a planar image conversion or a lens aberration corrected image.

### BACKGROUND ART

Cameras (e.g., closed-circuit television (CCTV)) installed to manage parking lots generally shoot the parking lot floor at a certain angle. Due to this shooting angle, there may be a hidden area in a taken image or distortions due to the camera lens aberration. Therefore, it is sometimes difficult to judge the situation by only analyzing such images.

### SUMMARY

One embodiment of the present disclosure provides an apparatus and method for parking management based on a planar image conversion.

Another embodiment of the present disclosure provides an apparatus and method for parking management based on a lens aberration corrected image.

According to an embodiment of the present disclosure, a method for parking management may include: by an image processor, receiving a plurality of streaming images of a parking lot taken by a plurality of imaging devices arranged at different locations in a direction forming a predetermined angle with a parking lot floor; by the image processor, extracting frames from each of the plurality of streaming images at regular intervals to generate a plurality of oblique images and then generating a plurality of oblique image groups arranged in time order from the generated plurality of oblique images; by an image convertor, generating a plurality of planar images arranged in time order by processing the plurality of oblique image groups; by a parking controller, detecting bounding boxes of a parking space and of a vehicle from the plurality of planar images arranged in time order through a detection model; and by the parking controller, determining whether the vehicle is parked or not in the parking space, based on a change in a degree of overlap between the bounding box of the parking space and the bounding box of the vehicle detected in time order.

The method may further include: before receiving the plurality of streaming images, by a relationship deriver, preparing a training planar image which is a target planar image; by the relationship deriver, collecting a plurality of training streaming images from the plurality of imaging devices; by the relationship deriver, extracting a plurality of training oblique images from the plurality of training streaming images; and by the relationship deriver, deriving a homography corresponding to each of the plurality of training oblique images by comparing each of the plurality of training oblique images with the training planar image.

In the method, when a matrix representing a homography, hᵢⱼ (i≤1, j≤3), satisfies Equation 1, the relationship deriver derives the matrix that minimizes Equation 2 as the homography,

$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 1 ]$$

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 2 ]$$

where (xᵢ, yᵢ) represents coordinates of the training oblique image, and (xᵢ′, yᵢ′) represents coordinates of the training planar image.

In the method, generating the plurality of planar images may include: by the image convertor, generating a plurality of planar slice images by applying the homography to the plurality of oblique images; and by the image convertor, generating the planar image by aligning the plurality of planar slice images.

In the method, determining whether the vehicle is parked or not may include: by the parking controller, calculating an intersection over union (IOU) between the bounding boxes of the parking space and of the vehicle from the plurality of planar images arranged in time order; and by the parking controller, determining that the vehicle is parked in the parking space if the calculated IOU increases in time sequence and then remains unchanged, or determining that the vehicle exits the parking space if the calculated IOU decreases and then becomes zero.

In the method, in case where the vehicle is parked, the parking controller may perform: calculating a reference value indicating a ratio of the bounding box of the parking space to the bounding box of the vehicle; if the IOU is smaller than the reference value, determining that a parking status of the vehicle is incorrect; and transmitting a guidance broadcast to guide the vehicle to correctly park while keeping to a parking line.

In the method, generating the plurality of oblique image groups may include: by the image processor, extracting frames from the plurality of streaming images at regular intervals and thereby generating the plurality of oblique images; by the image processor, generating the plurality of oblique image groups by grouping oblique images having a same time stamp from among the plurality of oblique images; and by the image processor, arranging the plurality of oblique image groups in time order of time stamps.

The method may further include: before receiving the plurality of streaming images, by a model generator, preparing learning data that includes a planar image and a label corresponding to the planar image, wherein the planar image contains a vehicle and a parking space, and the label is a ground-truth box indicating an area occupied by each of the vehicle and the parking space in the planar image; by the model generator, inputting the planar image into an untrained detection model; by the detection model, performing a plurality of operations in which untrained inter-layer weights are applied to the planar image, and thereby detecting a bounding box indicating an area occupied by each of the vehicle and the parking space in the planar image; by the model generator, calculating a loss indicating a difference between the detected bounding box and the ground-truth box; and by the model generator, performing optimization to modify the weights of the detection model so that the calculated loss is minimized.

According to an embodiment of the present disclosure, an apparatus for parking management may include: an image processor configured to receive a plurality of streaming images of a parking lot taken by a plurality of imaging devices arranged at different locations in a direction forming a predetermined angle with a parking lot floor, to extract frames from each of the plurality of streaming images at regular intervals to generate a plurality of oblique images, and to generate a plurality of oblique image groups arranged in time order from the generated plurality of oblique images; an image convertor configured to generate a plurality of planar images arranged in time order by processing the plurality of oblique image groups; and a parking controller configured to detect bounding boxes of a parking space and of a vehicle from the plurality of planar images arranged in time order through a detection model, and to determine whether the vehicle is parked or not in the parking space, based on a change in a degree of overlap between the bounding box of the parking space and the bounding box of the vehicle detected in time order.

The apparatus may further include a relationship deriver configured to: prepare a training planar image which is a target planar image, collect a plurality of training streaming images from the plurality of imaging devices, extract a plurality of training oblique images from the plurality of training streaming images, and derive a homography corresponding to each of the plurality of training oblique images by comparing each of the plurality of training oblique images with the training planar image.

In the apparatus, when a matrix representing a homography, hᵢⱼ (i≤1, j≤3), satisfies Equation 1, the relationship deriver may derive the matrix that minimizes Equation 2 as the homography,

$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 1 ]$$

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 2 ]$$

where (xᵢ, yᵢ) represents coordinates of the training oblique image, and (xᵢ′, yᵢ′) represents coordinates of the training planar image.

In the apparatus, the image convertor may be configured to: generate a plurality of planar slice images by applying the homography to the plurality of oblique images, and generate the planar image by aligning the plurality of planar slice images.

In the apparatus, the parking controller may be configured to: calculate an intersection over union (IOU) between the bounding boxes of the parking space and of the vehicle from the plurality of planar images arranged in time order, and determine that the vehicle is parked in the parking space if the calculated IOU increases in time sequence and then remains unchanged, or determine that the vehicle exits the parking space if the calculated IOU decreases and then becomes zero.

In the apparatus, the parking controller may be configured to: upon determining that the vehicle is parked in the parking space, calculate a reference value indicating a ratio of the bounding box of the parking space to the bounding box of the vehicle, if the IOU is smaller than the reference value, determine that a parking status of the vehicle is incorrect, and transmit a guidance broadcast to guide the vehicle to correctly park while keeping to a parking line.

In the apparatus, the image processor may be configured to: extract frames from the plurality of streaming images at regular intervals and thereby generate the plurality of oblique images, generate the plurality of oblique image groups by grouping oblique images having a same time stamp from among the plurality of oblique images, and arrange the plurality of oblique image groups in time order of time stamps.

The apparatus may further include a model generator configured to: prepare learning data that includes a planar image and a label corresponding to the planar image, wherein the planar image contains a vehicle and a parking space, and the label is a ground-truth box indicating an area occupied by each of the vehicle and the parking space in the planar image, input the planar image into an untrained detection model, perform a plurality of operations in which untrained inter-layer weights are applied to the planar image, and thereby detecting a bounding box indicating an area occupied by each of the vehicle and the parking space in the planar image, calculate a loss indicating a difference between the detected bounding box and the ground-truth box, and perform optimization to modify the weights of the detection model so that the calculated loss is minimized.

According to an embodiment of the present disclosure, a method for parking management may include: by an image processor, receiving a streaming image of a parking lot taken by an imaging device in a direction forming a predetermined angle with a parking lot floor; by the image processor, generating a plurality of oblique images by extracting frames from the streaming image at regular intervals; by an image corrector, generating a plurality of corrected images arranged in time order by correcting distortion caused by aberration of a camera lens of the imaging device for the plurality of oblique images; by a parking controller, detecting bounding boxes of a parking space and of a vehicle from the plurality of arranged corrected images through a detection model; and by the parking controller, determining whether the vehicle is parked or not in the parking space, by analyzing a change in a degree of overlap between the bounding box of the parking space and the bounding box of the vehicle according to time sequence.

In the method, generating the plurality of corrected images may include: by the image corrector, converting correction coordinates, which are pixel coordinates of the corrected image, into intermediate coordinates, which are pixel coordinates from which influence of camera parameters is removed, based on the camera parameters of the imaging device; by the image corrector, calculating a distance to a center of the intermediate coordinate; by the image corrector, deriving distortion coordinates by applying the distortion caused by the aberration of the camera lens of the imaging device to the intermediate coordinates, based on the calculated distance to the center; by the image corrector, deriving oblique coordinates, which are pixel coordinates of the oblique image, by applying the camera parameters to the distortion coordinates; and by the image corrector, generating the corrected image by configuring pixel values of the oblique coordinates derived in response to the correction coordinates into pixel values of the correction coordinates.

In the method, upon converting into the intermediate coordinates, the image corrector may derive the intermediate coordinates according to Equation,

$$[ \begin{matrix}{x}_{m} \\ {y}_{m} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{r} \\ {y}_{r} \\ 1\end{matrix} ]$$

where (xₘ, yₘ) represents the intermediate coordinates, (xᵣ, yᵣ) represents the correction coordinates, (fₓ, f_{y}) is the focal length among the camera parameters, (cₓ, c_{y}) is the coordinates of the lens center among the camera parameters, and skew represents the asymmetry coefficient among the camera parameters.

In the method, upon calculating the distance to the center, the image corrector may calculate the distance to the center according to Equation,

$${r}_{c}^{2} = {x}_{m}^{2} + {y}_{m}^{2}$$

where (xₘ, yₘ) is the intermediate coordinates, and r_{c} represents the distance to the center of the intermediate coordinates.

In the method, upon deriving the oblique coordinates, the image corrector may drive the distortion coordinates according to Equation,

$$[ \begin{matrix}{x}_{d} \\ {y}_{d}\end{matrix} ] = ( 1 + {k}_{1} {r}_{c}^{2} + {k}_{2} {r}_{c}^{4} + {k}_{3} {r}_{c}^{6} ) [ \begin{matrix}{x}_{m} \\ {y}_{m}\end{matrix} ] + [ \begin{matrix}2 {P}_{1} {x}_{m} {y}_{m} + {P}_{2} ( {r}_{c}^{2} + 2 {x}_{m}^{2} ) \\ {P}_{1} ( {r}_{c}^{2} + 2 {y}_{m}^{2} ) + 2 {P}_{2} {x}_{m} {y}_{m}\end{matrix} ]$$

where (x_{d}, y_{d}) represents the distortion coordinates, which are distorted pixel coordinates due to the lens aberration, (xₘ, yₘ) is the intermediate coordinates, r_{c} represents the distance to the center of the intermediate coordinates, k₁, k₂ and k₃ represent radial distortion coefficients, and P₁ and P₂ represent tangential distortion coefficients.

In the method, upon deriving the oblique coordinates, the image corrector may derive the oblique coordinates according to Equation,

$$[ \begin{matrix}{x}_{g} \\ {y}_{g} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{d} \\ {y}_{d} \\ 1\end{matrix} ]$$

where (x_{g}, y_{g}) represents the oblique coordinates, (x_{d}, y_{d}) represents the distortion coordinates, which are pixel coordinates distorted by lens aberration, (fₓ, f_{y}) is the focal length among the camera parameters, (cₓ, c_{y}) is the coordinates of the lens center among the camera parameters, and skew represents the asymmetry coefficient among the camera parameters.

In the method, determining whether the vehicle is parked or not may include: by the parking controller, calculating an intersection over union (IOU) between the bounding boxes of the parking space and of the vehicle from the plurality of corrected images; and by the parking controller, determining that the vehicle is parked in the parking space if the calculated IOU increases and then remains unchanged, or determining that the vehicle exits the parking space if the calculated IOU decreases and then becomes zero.

In the method, in case where the vehicle is parked, the parking controller may perform: calculating a reference value indicating a ratio of the bounding box of the parking space to the bounding box of the vehicle; if the IOU is smaller than the reference value, determining that a parking status of the vehicle is incorrect; and transmitting a guidance broadcast to guide the vehicle to correctly park while keeping to a parking line.

The method may further include: before receiving the plurality of streaming images, by a model generator, preparing learning data that includes a corrected image and a label corresponding to the corrected image, wherein the corrected image contains a vehicle and a parking space, and the label is a ground-truth box indicating an area occupied by each of the vehicle and the parking space in the corrected image; by the model generator, inputting the corrected image into an untrained detection model; by the detection model, performing a plurality of operations in which untrained inter-layer weights are applied to the corrected image, and thereby detecting a bounding box indicating an area occupied by each of the vehicle and the parking space in the corrected image; by the model generator, calculating a loss indicating a difference between the detected bounding box and the ground-truth box; and by the model generator, performing optimization to modify the weights of the detection model so that the calculated loss is minimized.

According to an embodiment of the present disclosure, an apparatus for parking management may include: an image processor configured to receive a streaming image of a parking lot taken by an imaging device in a direction forming a predetermined angle with a parking lot floor, and to generate a plurality of oblique images by extracting frames from the streaming image at regular intervals; an image corrector configured to generate a plurality of corrected images arranged in time order by correcting distortion caused by aberration of a camera lens of the imaging device for the plurality of oblique images; and a parking controller configured to detect bounding boxes of a parking space and of a vehicle from the plurality of arranged corrected images through a detection model, and to determine whether the vehicle is parked or not in the parking space, by analyzing a change in a degree of overlap between the bounding box of the parking space and the bounding box of the vehicle according to time sequence.

In the apparatus, the image corrector may be configured to: convert correction coordinates, which are pixel coordinates of the corrected image, into intermediate coordinates, which are pixel coordinates from which influence of camera parameters is removed, based on the camera parameters of the imaging device, calculate a distance to a center of the intermediate coordinate, derive distortion coordinates by applying the distortion caused by the aberration of the camera lens of the imaging device to the intermediate coordinates, based on the calculated distance to the center, derive oblique coordinates, which are pixel coordinates of the oblique image, by applying the camera parameters to the distortion coordinates, and generate the corrected image by configuring pixel values of the oblique coordinates derived in response to the correction coordinates into pixel values of the correction coordinates.

In the apparatus, the image corrector may derive the intermediate coordinates according to Equation,

$$[ \begin{matrix}{x}_{m} \\ {y}_{m} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{r} \\ {y}_{r} \\ 1\end{matrix} ]$$

where (xₘ, yₘ) represents the intermediate coordinates, (xᵣ, yᵣ) represents the correction coordinates, (fₓ, f_{y}) is the focal length among the camera parameters, (cₓ, c_{y}) is the coordinates of the lens center among the camera parameters, and skew represents the asymmetry coefficient among the camera parameters.

In the apparatus, the image corrector may calculate the distance to the center according to Equation,

$${r}_{c}^{2} = {x}_{m}^{2} + {y}_{m}^{2}$$

where (xₘ, yₘ) is the intermediate coordinates, and rₑ represents the distance to the center of the intermediate coordinates.

In the apparatus, the image corrector may drive the distortion coordinates according to Equation,

$$[ \begin{matrix}{x}_{d} \\ {y}_{d}\end{matrix} ] = ( 1 + {k}_{1} {r}_{c}^{2} + {k}_{2} {r}_{c}^{4} + {k}_{3} {r}_{c}^{6} ) [ \begin{matrix}{x}_{m} \\ {y}_{m}\end{matrix} ] + [ \begin{matrix}2 {P}_{1} {x}_{m} {y}_{m} + {P}_{2} ( {r}_{c}^{2} + 2 {x}_{m}^{2} ) \\ {P}_{1} ( {r}_{c}^{2} + 2 {y}_{m}^{2} ) + 2 {P}_{2} {x}_{m} {y}_{m}\end{matrix} ]$$

where (x_{d}, y_{d}) represents the distortion coordinates, which are distorted pixel coordinates due to the lens aberration, (xₘ, yₘ) is the intermediate coordinates, r_{c} represents the distance to the center of the intermediate coordinates, k₁, k₂ and k₃ represent radial distortion coefficients, and P₁ and P₂ represent tangential distortion coefficients.

In the apparatus, the image corrector may derive the oblique coordinates according to Equation,

$$[ \begin{matrix}{x}_{g} \\ {y}_{g} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{d} \\ {y}_{d} \\ 1\end{matrix} ]$$

where (x_{g}, y_{g}) represents the oblique coordinates, (x_{d}, y_{d}) represents the distortion coordinates, which are pixel coordinates distorted by lens aberration, (fₓ, f_{y}) is the focal length among the camera parameters, (cₓ, c_{y}) is the coordinates of the lens center among the camera parameters, and skew represents the asymmetry coefficient among the camera parameters.

In the apparatus, the parking controller may be configured to: calculate an intersection over union (IOU) between the bounding boxes of the parking space and of the vehicle from the plurality of corrected images, and determine that the vehicle is parked in the parking space if the calculated IOU increases and then remains unchanged, or determine that the vehicle exits the parking space if the calculated IOU decreases and then becomes zero.

In the apparatus, the parking controller may be configured to: upon determining that the vehicle is parked in the parking space, calculate a reference value indicating a ratio of the bounding box of the parking space to the bounding box of the vehicle, if the IOU is smaller than the reference value, determine that a parking status of the vehicle is incorrect, and transmit a guidance broadcast to guide the vehicle to correctly park while keeping to a parking line.

The apparatus may further include a model generator configured to: prepare learning data that includes a corrected image and a label corresponding to the corrected image, wherein the corrected image contains a vehicle and a parking space, and the label is a ground-truth box indicating an area occupied by each of the vehicle and the parking space in the corrected image, input the corrected image into an untrained detection model, perform a plurality of operations in which untrained inter-layer weights are applied to the corrected image, and thereby detecting a bounding box indicating an area occupied by each of the vehicle and the parking space in the corrected image, calculate a loss indicating a difference between the detected bounding box and the ground-truth box, and perform optimization to modify the weights of the detection model so that the calculated loss is minimized.

According to the present disclosure, parking management can be performed more accurately and efficiently by analyzing a planar image converted from an oblique image of a parking lot taken in an oblique shooting direction.

In addition, according to the present disclosure, parking management can be performed more accurately and efficiently by analyzing a corrected image obtained by correcting distortion due to lens aberration in a parking lot image.

### DESCRIPTION OF DRAWINGS

FIG. 1 is a schematic diagram illustrating a system for parking management according to embodiments of the present disclosure.

FIG. 2 is a schematic diagram illustrating a shooting direction of an imaging device according to embodiments of the present disclosure.

FIG. 3 is a block diagram illustrating the configuration of an apparatus for parking management based on a planar image conversion according to the first embodiment of the present disclosure.

FIG. 4 is a flowchart illustrating a method for generating a detection model according to the first embodiment of the present disclosure.

FIG. 5 is a flowchart illustrating a method for deriving a homography according to the first embodiment of the present disclosure.

FIG. 6 is a flowchart illustrating a method for parking management based on a planar image conversion according to the first embodiment of the present disclosure.

FIGS. 7 to 9 are exemplary views illustrating a method for parking management based on a planar image conversion according to the first embodiment of the present disclosure.

FIG. 10 is an exemplary view illustrating an oblique image and a corrected image according to the second embodiment of the present disclosure.

FIG. 11 is a block diagram illustrating the configuration of an apparatus for parking management based on a lens aberration corrected image according to the second embodiment of the present disclosure.

FIG. 12 is a flowchart illustrating a method for generating a detection model according to the second embodiment of the present disclosure.

FIG. 13 is a flowchart illustrating a method for parking management based on a corrected image conversion according to the second embodiment of the present disclosure.

FIG. 14 is an exemplary view illustrating a method for parking management based on a corrected image conversion according to the second embodiment of the present disclosure.

FIG. 15 is a flowchart illustrating a method for generating a corrected image by correcting an oblique image according to the second embodiment of the present disclosure.

FIG. 16 is a diagram illustrating a hardware system for implementing the apparatus according to the first and second embodiments of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

### Parking Management System

At the outset, a system for parking management according to embodiments of the present disclosure will be described.

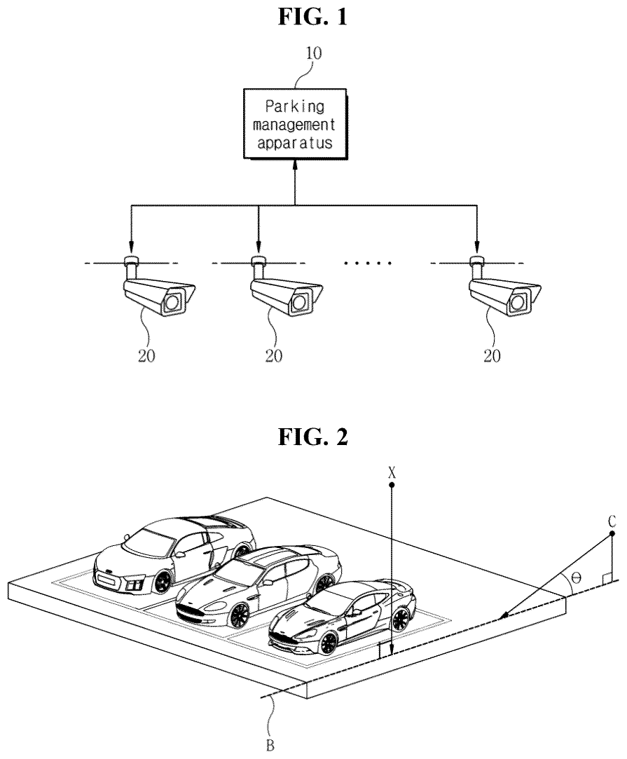

FIG. 1 is a schematic diagram illustrating a system for parking management according to embodiments of the present disclosure. FIG. 2 is a schematic diagram illustrating a shooting direction of an imaging device according to embodiments of the present disclosure.

Referring to FIG. 1, the parking management system according to embodiments of the present disclosure includes a parking management apparatus 10 and a plurality of imaging devices 20.

The imaging device 20 is a device including a camera for taking streaming images. For example, the imaging device 20 may be a closed-circuit television (CCTV). The imaging device 20 may include a camera for taking streaming images, a transceiver for transmitting the taken images to the parking management apparatus 10, and a microcontroller unit (MCU) for controlling the camera and the transceiver.

The parking management apparatus 10 receives a plurality of streaming images from the plurality of imaging devices 20 and analyzes the received streaming images to perform parking management.

Referring to FIG. 2, the plurality of imaging devices 20 are arranged at different locations to take images of the parking lot in a direction forming a certain angle (0) with the parking lot floor (B). That is, each imaging device 20 takes an image in an oblique direction from its location indicated by reference symbol C. Due to this, an area hidden by a vehicle cannot be seen in a frame of a streaming image, and thus, it is difficult to accurately determine the parking, exiting, and parking status. To solve this problem, the parking management apparatus 10 generates a planar image by processing the frame of the streaming image and analyzes the planar image through a detection model (DM), which is a learning model (e.g., deep learning model), to determine the parking, exiting, and parking status. The planar image refers to an image of a parking lot viewed from the sky, like a plan view. That is, the planar image represents an image of the parking lot taken by a virtual camera from a position (X) looking vertically at the parking lot floor (B), as shown in FIG. 2.

### First Embodiment

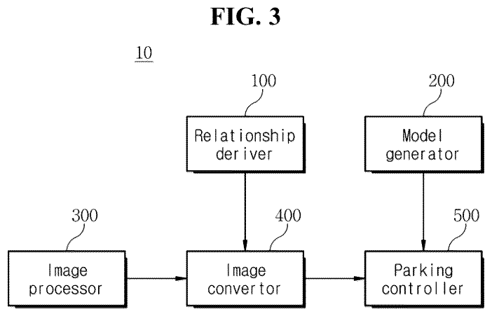

Now, the parking management apparatus 10 according to the first embodiment of the present disclosure will be described in detail. FIG. 3 is a block diagram illustrating the configuration of an apparatus for parking management based on a planar image conversion according to the first embodiment of the present disclosure.

Referring to FIG. 3, the parking management apparatus 10 includes a relationship deriver 100, a model generator 200, an image processor 300, an image convertor 400, and a parking controller 500.

The relationship deriver 100 is a component for deriving a homography according to the first embodiment. The relationship deriver 100 derives a homography corresponding to each of the plurality of imaging devices 20.

The model generator 200 is a component for generating a detection model (DM) through learning (e.g., deep learning). The detection model is trained to detect a bounding box representing an area occupied by each of a parking space and a vehicle in a planar image. When the detection model is generated, the model generator 200 provides the detection model to the parking controller 500.

The detection model includes a plurality of layers, and each of the plurality of layers performs a plurality of operations. In one layer, each result of the plurality of operations is weighted and transmitted to the next layer. This means that weights are applied to the operation results of the current layer and input to the operations of the next layer. In other words, the detection model performs a plurality of operations to which the weights of the plurality of layers are applied. The plurality of layers of the detection model may include at least one of a fully-connected layer, a convolutional layer, a recurrent layer, a graph layer, and a pooling layer. The plurality of operations may include at least one of a convolution operation, a down sampling operation, an up sampling operation, a pooling operation, and an operation by an activation function. Here, the activation function may include a sigmoid, a hyperbolic tangent (tanh), an exponential linear unit (ELU), a rectified linear unit (ReLU), a leakly ReLU, a Maxout, a Minout, or a Softmax. The detection model may be, for example, R-CNN, R-FCN, FPN-FPCN, YOLO, SDD, RetinaNet, etc. When an image is input, the detection model performs a plurality of operations in which weights of a plurality of layers are applied to the input image, and thereby detects bounding boxes representing the areas occupied by objects (i.e., vehicles and parking spaces).

The image processor 300 may receive a plurality of streaming images from the plurality of imaging devices 20. Then, the image processor 300 extracts frames from each of the plurality of streaming images at regular intervals to generate a plurality of oblique images, and generates a plurality of oblique image groups arranged in time order from the generated plurality of oblique images.

The image convertor 400 is a component for sequentially processing the plurality of oblique image groups arranged in time order and thereby generating a plurality of planar images arranged in time order. The image convertor 400 uses the homography derived by the relationship deriver 100 to generate, from the plurality of oblique images, a plurality of planar slice images corresponding to the plurality of oblique images, and aligns the plurality of planar slice images to generate a planar image.

The parking controller 500 detects the bounding boxes of parking spaces and vehicles from the plurality of planar images arranged in time order through the detection model (DM), and checks whether a vehicle is parked or not in a parking space based on a change in the degree of overlap between the detected bounding box of the parking space and the detected bounding box of the vehicle. In addition, when the vehicle is parked, the parking controller 500 checks the parking status, and if the parking status is not correct, transmits an announcement to guide correct parking.

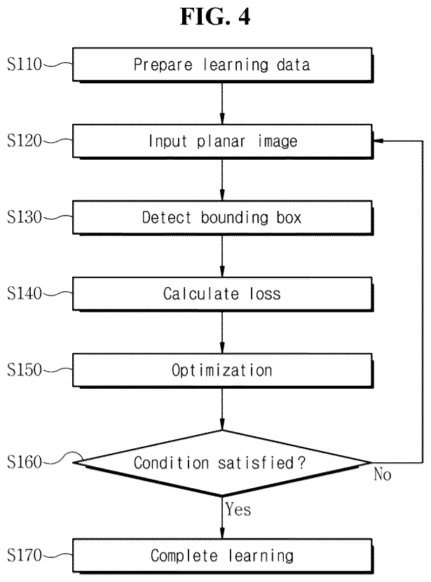

Next, a method for generating the detection model (DM) according to the first embodiment of the present disclosure will be described. FIG. 4 is a flowchart illustrating a method for generating a detection model according to the first embodiment of the present disclosure.

Referring to FIG. 4, in step S110, the model generator 200 prepares learning data for training the detection model (DM). The learning data includes a planar image and a label corresponding to the planar image. The planar image refers to an image of a parking lot viewed from the sky, like a plan view. For example, as shown in FIG. 2, the planar image represents an image of the parking lot taken by a virtual camera from a position (X) looking vertically at the parking lot floor (B). The label is a bounding box indicating an area occupied by each of a vehicle and a parking space in the planar image. The bounding box used as the label is called a ground-truth (GT) box to be distinguished from the aforementioned bounding box detected by the detection model. The ground-truth box is defined by the center coordinates (x, y) and the width and height (w, h).

When the learning data is prepared, in step S120, the model generator 200 inputs the planar image into an untrained detection model (i.e., a detection model whose learning is uncompleted).

Then, in step S130, the detection model performs a plurality of operations in which a plurality of untrained inter-layer weights are applied to the planar image, and thereby detects a bounding box (BB) that indicates an area occupied by each of a vehicle and a parking space in the planar image.

Then, in step S140, the model generator 200 calculates a loss indicating a difference between the detected bounding box and the ground-truth box through a loss function.

Next, in step S150, the model generator 200 performs optimization to modify the weights of the detection model so that the loss calculated through the loss function is minimized.

The above-described steps S120 to S150 are repeatedly performed using a plurality of different learning data, and the weights of the detection model are repeatedly updated according to this repetition. In addition, this repetition is performed until the calculated loss converges and becomes lower than a predetermined target value.

Therefore, in step S160, the model generator 200 determines whether the loss calculated previously in the step S140 converges and becomes lower than the predetermined target value. If the calculated loss is lower than the predetermined target value, that is, if the learning completion condition is met, the model generator 200 completes the learning for the detection model in step S170.

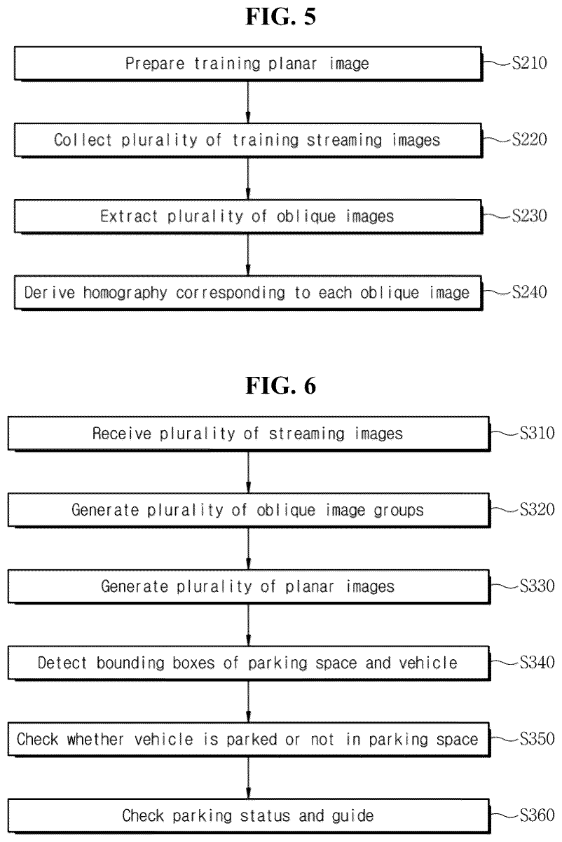

Next, a method for deriving a homography according to the first embodiment of the present disclosure will be described. FIG. 5 is a flowchart illustrating a method for deriving a homography according to the first embodiment of the present disclosure.

Referring to FIG. 5, in step S210, the relationship deriver 100 prepares a training planar image, which is a target planar image. The training planar image refers to an image of a parking lot viewed from the sky, like a plan view. In other words, the training planar image is an image of the parking lot taken by a virtual camera (X) at a position (X) perpendicular to the parking lot floor (B), as in FIG. 2.

Then, in step S220, the relationship deriver 100 collects a plurality of training streaming images from the plurality of imaging devices 20. As shown in FIG. 2, the plurality of imaging devices 20 are arranged at different locations and take images of the parking lot in a direction forming a certain angle (0) with the parking lot floor (B).

Next, in step S230, the relationship deriver 100 extracts a plurality of training oblique images from the plurality of training streaming images. Here, the training oblique image represents one of frames of the training streaming image. In particular, when extracting the plurality of training oblique images from the plurality of training streaming images, it is preferable to extract frames having the same time stamp. For example, if there are the first to fourth imaging devices 20, the first training oblique image is extracted from the first training streaming image taken by the first imaging device, the second training oblique image is extracted from the second training streaming image taken by the second imaging device, the third training oblique image is extracted from the third training streaming image taken by the third imaging device, and the fourth training oblique image is extracted from the fourth training streaming image taken by the fourth imaging device. In this case, the first to fourth training oblique images correspond to frames with the same time stamp.

Next, in step S240, the relationship deriver 100 compares each of the plurality of training oblique images extracted in the step S230 with the training planar image prepared in the step S210 and thereby derives a homography corresponding to each of the plurality of training oblique images. In other words, the relationship deriver 100 derives a homography corresponding to each of the plurality of imaging devices 20. For example, the relationship deriver 100 can derive first to fourth homographies corresponding to the first to fourth training oblique images, respectively. This means deriving the first to fourth homographies corresponding to the first to fourth imaging devices 20.

If Equation 1 below is satisfied where a matrix representing a homography is denoted by hᵢⱼ(i≤1, j≤3), the relationship deriver 100 can derive the matrix that minimizes Equation 2 below as the homography.

$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 1 ]$$

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 2 ]$$

Here, (xᵢ, yᵢ) represents the coordinates of the training oblique image, and (xᵢ′, yᵢ′) represents the coordinates of the training planar image.

As above, once the detection model learning is completed and the homography is derived, parking management based on a planar image conversion can be performed. Now, this method will be described in detail.

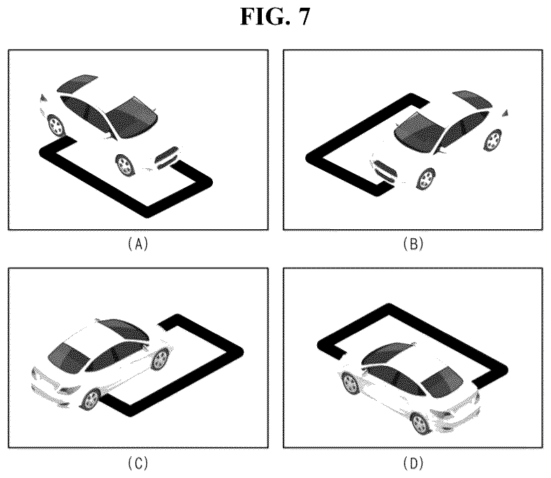

FIG. 6 is a flowchart illustrating a method for parking management based on a planar image conversion according to the first embodiment of the present disclosure. FIGS. 7 to 9 are exemplary views illustrating a method for parking management based on a planar image conversion according to the first embodiment of the present disclosure.

Referring to FIG. 6, in step S310, the image processor 300 receives a plurality of streaming images from the plurality of imaging devices 20. The plurality of imaging devices 20 are arranged at different locations and take images of the parking lot in a direction forming a certain angle (θ) with the parking lot floor (B). For example, it is assumed that there are first to fourth imaging devices 20. Thus, the image processor 300 can receive first to fourth streaming images.

Next, in step S320, the image processor 300 extracts frames from each of the plurality of streaming images at regular intervals to generate a plurality of oblique images, and generates a plurality of oblique image groups arranged in time order from the generated plurality of oblique images.

Specifically, in the S320, the image processor 300 first extracts frames from the plurality of streaming images at regular intervals and thereby generates a plurality of oblique images. That is, the image processor 300 extracts frames from a first streaming image at regular intervals to generate a plurality of first oblique images, extracts frames from a second streaming image at regular intervals to generate a plurality of second oblique images, extracts frames from a third streaming image at regular intervals to generate a plurality of third oblique images, and extracts frames from a fourth streaming image at regular intervals to generate a plurality of fourth oblique images. For example, as shown in (A) to (D) of FIG. 7, oblique images are extracted from each of the plurality of streaming images at regular intervals. Next, the image processor 300 generates a plurality of oblique image groups by grouping oblique images having the same time stamp from among the extracted oblique images. At this time, the image processor 300 selects four oblique images having the same time stamp from among the plurality of first oblique images, the plurality of second oblique images, the plurality of third oblique images, and the plurality of fourth oblique images, and combines the selected four oblique images into one oblique image group. For example, if four oblique images shown in (A) to (D) of FIG. 7 have the same time stamp, they can be one oblique image group. Then, the image processor 300 arranges the plurality of oblique image groups in time order of the time stamps.

Next, in step S330, the image convertor 400 sequentially processes the plurality of oblique image groups arranged in time order and thereby generates a plurality of planar images arranged in time order.

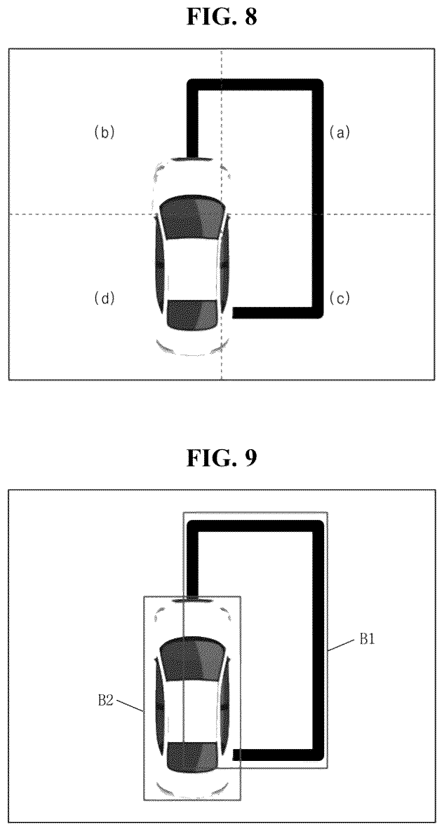

Specifically, in the S330, the image convertor 400 applies the homography derived in advance (see FIG. 5) to the plurality of oblique images for each oblique image group and thereby generates a plurality of planar slice images. As described above with reference to FIG. 5, the homography corresponding to the imaging device 20 is derived. Therefore, the image convertor 400 can apply the homography (derived corresponding to the imaging device 20 that is the basis of the oblique image) to the corresponding oblique image, thereby converting the oblique image into a planar slice image that is perspective-transformed to fit the planar image. Since the planar slice image is based on the oblique image, an area that is not visible in the oblique image remain as a null value. Therefore, the image convertor 400 generates the planar image by aligning the plurality of planar slice images. One example of the planar image is shown in FIG. 8. The planar image of FIG. 8 is generated by aligning four planar slice images, and four parts (a), (b), (c), and (d) of the planar image correspond to the planar slice images that are perspective-transformed from the four oblique images shown in (A) to (D) of FIG. 7.

Next, in step S340, the parking controller 500 detects the bounding boxes of parking spaces and vehicles from the plurality of planar images arranged in time order through the detection model. One example of the bounding boxes is shown in FIG. 9. As shown, the detection model can detect the bounding box (B1) of a parking space and the bounding box (B2) of a vehicle.

Next, in step S350, the parking controller 500 checks whether the vehicle is parked or not in the parking space, based on a change in the degree of overlap between the bounding box of the parking space and the bounding box of the vehicle detected in time sequence.

Specifically, in the S350, the parking controller 500 calculates according to Equation 3 below an intersection over union (IOU) between the bounding boxes of the parking space and of the vehicle from the plurality of planar images sorted in time order.

$$\frac{P ⋂ C}{P ⋃ C} \qquad [ Equation 3 ]$$

Here, ‘P’ denotes the area of the parking space bounding box, and ‘C’ denotes the area of the vehicle bounding box.

The parking controller 500 determines that the vehicle is parked in the parking space if the calculated IOU increases in time sequence and then remains unchanged, and determines that the vehicle exits the parking space if the calculated IOU decreases and then becomes zero.

Meanwhile, in the case where the vehicle is parked, the parking controller 500 may check a parking status in step S360. If the parking status is not correct, the parking controller 500 may guide the vehicle to be parked correctly. To this end, the parking controller 500 calculates a reference value indicating the ratio of the bounding box of the parking space to the bounding box of the vehicle. Then, if the IOU is smaller than the reference value, the parking controller 500 determines that the parking status of the vehicle is incorrect, that is, a wrong parking status. In the case of the wrong parking status, the parking controller 500 may transmit a guidance broadcast to guide the vehicle to correctly park while keeping to the parking line.

### Second Embodiment

Now, a system for parking management according to the second embodiment of the present disclosure will be described.

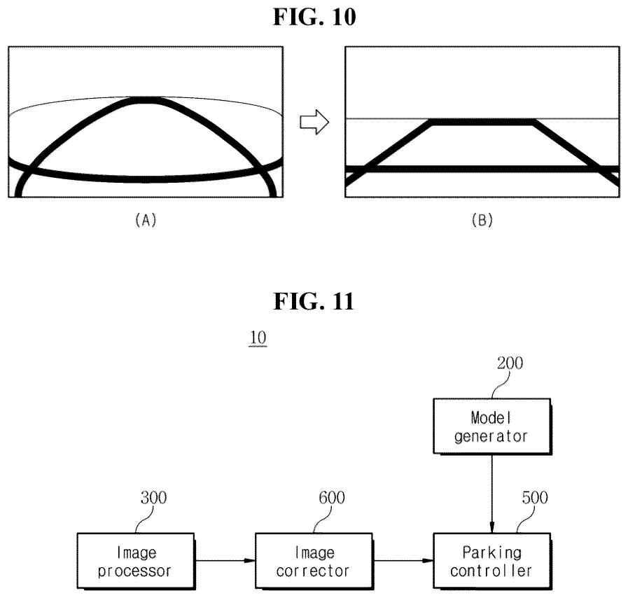

In the second embodiment, the aforementioned FIGS. 1 and 2 are applied equally. In addition, FIG. 10 is an exemplary view illustrating an oblique image and a corrected image according to the second embodiment of the present disclosure.

Referring again to FIGS. 1 and 2, the imaging device 20 of the second embodiment is the same as described above. Meanwhile, the parking management apparatus 10 receives streaming images of a parking lot taken in an oblique direction relative to the parking lot floor from the plurality of imaging devices 20, and analyzes oblique images obtained by extracting frames from the received plurality of streaming images to perform parking management.

As described above, since the imaging device 20 takes an image of a parking lot in an oblique direction (i.e., in a direction forming a certain angle (θ) with the parking lot floor (B)) at the position indicated by reference symbol C in FIG. 2, the oblique image, which is an image obtained by extracting the frame of the streaming image, suffers from severe distortion due to the lens aberration of the camera of the imaging device 20. An example of the oblique image is shown in (A) of FIG. 10. As shown, in the oblique image, a parking line may appear as a curve due to distortion. It is therefore difficult to accurately determine the parking, exiting, and parking status by only image analysis. Thus, the parking management apparatus 10 according to the second embodiment corrects the distortion in the oblique image as shown in (A) of FIG. 10 and thereby generates a corrected image. An example of the corrected image is shown in (B) of FIG. 10. Unlike the oblique image, it can be seen that the parking line is formed as a straight line in the corrected image. Accordingly, the parking management apparatus 10 can accurately determine the parking, exiting, and parking status by analyzing the corrected image through a detection model (DM), which is one of learning models (e.g., deep learning models).

Hereinafter, the parking management apparatus 10 according to the second embodiment of the present disclosure will be described in detail. FIG. 11 is a block diagram illustrating the configuration of an apparatus for parking management based on a lens aberration corrected image according to the second embodiment of the present disclosure.

Referring to FIG. 11, the parking management apparatus 10 includes a model generator 200, an image processor 300, an image corrector 600, and a parking controller 500.

The model generator 200 is substantially the same as the model generator 200 described above in the first embodiment with reference to FIG. 3. Therefore, a duplicate description is omitted here.

The image processor 300 is substantially the same as the image processor 300 described above in the first embodiment with reference to FIG. 3. Therefore, a duplicate description is omitted here.

The image corrector 600 is a component for correcting the distortion of the oblique image and thereby generating a plurality of corrected images. This distortion is due to the lens aberration of the camera of the imaging device 20.

The parking controller 500 detects the bounding boxes of parking spaces and vehicles from the plurality of corrected images arranged in time order through the detection model (DM), and checks whether a vehicle is parked or not in a parking space based on a change in the degree of overlap between the detected bounding box of the parking space and the detected bounding box of the vehicle. In addition, when the vehicle is parked, the parking controller 500 checks the parking status, and if the parking status is not correct, transmits an announcement to guide correct parking.

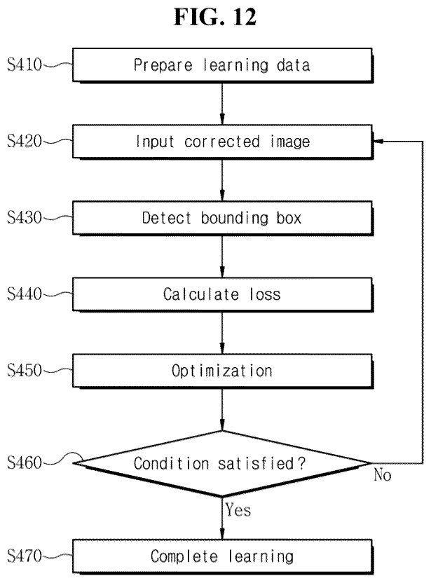

Next, a method for generating the detection model (DM) according to the second embodiment of the present disclosure will be described. FIG. 12 is a flowchart illustrating a method for generating a detection model according to the second embodiment of the present disclosure.

Referring to FIG. 12, in step S410, the model generator 200 prepares learning data for training the detection model (DM). The learning data includes a corrected image and a label corresponding to the corrected image. The corrected image refer to an image in which distortion due to lens aberration is corrected in the oblique image, as shown in (B) of FIG. 10. The label is a bounding box indicating an area occupied by each of a vehicle and a parking space in the corrected image. The bounding box used as the label is called a ground-truth (GT) box to be distinguished from the bounding box detected by the detection model. The ground-truth box is defined by the center coordinates (x, y) and the width and height (w, h).

When the learning data is prepared, in step S420, the model generator 200 inputs the corrected image into an untrained detection model (i.e., a detection model whose learning is uncompleted).

Then, in step S430, the detection model performs a plurality of operations in which a plurality of untrained inter-layer weights are applied to the corrected image, and thereby detects a bounding box (BB) that indicates an area occupied by each of a vehicle and a parking space in the corrected image.

Then, in step S440, the model generator 200 calculates a loss indicating a difference between the detected bounding box and the ground-truth box through a loss function.

Next, in step S450, the model generator 200 performs optimization to modify the weights of the detection model so that the loss calculated through the loss function is minimized.

The above-described steps S420 to S450 are repeatedly performed using a plurality of different learning data, and the weights of the detection model are repeatedly updated according to this repetition. In addition, this repetition is performed until the calculated loss converges and becomes lower than a predetermined target value.

Therefore, in step S460, the model generator 200 determines whether the loss calculated previously in the step S440 converges and becomes lower than the predetermined target value. If the calculated loss is lower than the predetermined target value, that is, if the learning completion condition is met, the model generator 200 completes the learning for the detection model in step S470.

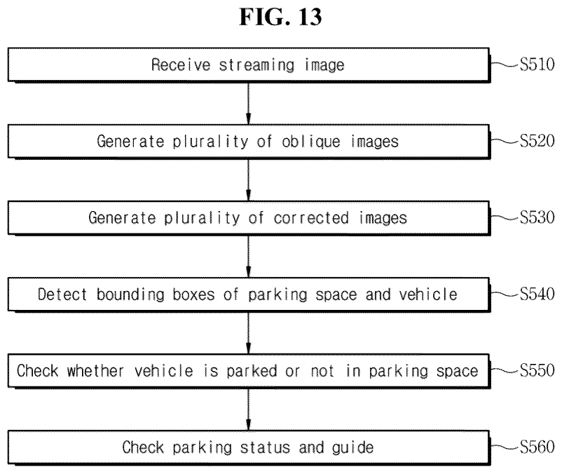

As above, once the detection model learning is completed, parking management based on the lens aberration corrected image can be performed. Now, this method will be described in detail. FIG. 13 is a flowchart illustrating a method for parking management based on a corrected image conversion according to the second embodiment of the present disclosure.

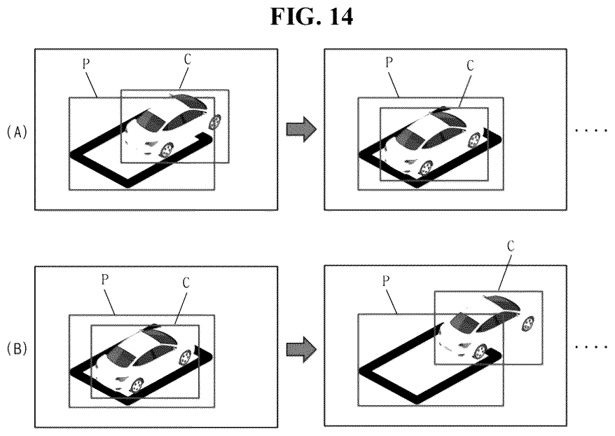

FIG. 14 is an exemplary view illustrating a method for parking management based on a corrected image conversion according to the second embodiment of the present disclosure.

Referring to FIG. 13, in step S510, the image processor 300 receives a streaming image from the imaging device 20. The imaging device 20 takes the image of the parking lot in a direction forming a certain angle (θ) with the parking lot floor (B).

Next, in step S520, the image processor 300 extracts frames from the streaming image at regular intervals and thereby generates a plurality of oblique images. As shown in FIG. 2, the imaging device 20 takes an image of a parking lot in an oblique direction (i.e., in a direction forming a certain angle (θ) with the parking lot floor (B)) at the position indicated by reference symbol C. Therefore, the oblique image, which is an image obtained by extracting the frame of the streaming image, suffers from severe distortion due to the lens aberration of the camera of the imaging device 20. An example of the oblique image is shown in (A) of FIG. 10. As shown, in the oblique image, a parking line may appear as a curve due to distortion.

For this reason, when analyzing the oblique image, it is difficult to accurately determine the parking, exiting, and parking status. Therefore, in step S530, the image corrector 600 corrects the distortion due to the aberration of the camera lens of the imaging device 20 for the plurality of oblique images and thereby generates a plurality of corrected images arranged in time order. An example of such a corrected image is shown in (B) of FIG. 10. As shown, unlike the oblique image, it can be seen that the parking line is formed as a straight line in the corrected image. A method for correcting the distortion in the S530 step will be described in more detail below.

Next, in step S540, the parking controller 500 detects the bounding boxes of parking spaces and vehicles from the plurality of corrected images arranged in time order through the detection model. One related example is shown in FIG. 14. As shown, the detection model can detect the bounding box (P) of a parking space and the bounding box (C) of a vehicle.

Next, in step S550, the parking controller 500 checks whether the vehicle is parked or not in the parking space, based on a change in the degree of overlap between the bounding box of the parking space and the bounding box of the vehicle detected in time sequence. At this time, according to Equation 3 described above in the first embodiment, the parking controller 500 calculates an intersection over union (IOU) between the bounding boxes of the parking space and of the vehicle from the plurality of corrected images sorted in time order. If the IOU calculated from the plurality of corrected images arranged in time order increases and then remains unchanged as shown in (A) of FIG. 14, the parking controller 500 determines that the vehicle is parked in the parking space. If the IOU calculated from the plurality of corrected images arranged in time order decreases and then becomes zero as shown in (B) of FIG. 14, the parking controller 500 determines that the vehicle exits the parking space.

In the case where the vehicle is parked, the parking controller 500 may check a parking status in step S560. If the parking status is not correct, the parking controller 500 may guide the vehicle to be parked correctly. To this end, the parking controller 500 calculates a reference value indicating the ratio (P/C) of the bounding box (P) of the parking space to the bounding box (C) of the vehicle. Then, if the IOU is smaller than the reference value, the parking controller 500 determines that the parking status of the vehicle is incorrect, that is, a wrong parking status. In the case of the wrong parking status, the parking controller 500 may transmit a guidance broadcast to guide the vehicle to correctly park while keeping to the parking line.

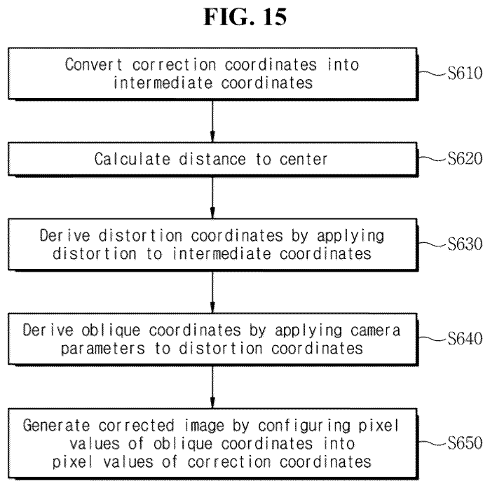

Meanwhile, the above-described step S530 will be described in more detail. FIG. 15 is a flowchart illustrating a method for generating a corrected image by correcting an oblique image according to the second embodiment of the present disclosure. That is, FIG. 15 is a detailed process of the step S530.

Referring to FIG. 15, in step S610, the image corrector 600 converts the correction coordinates, which are pixel coordinates of the corrected image, into intermediate coordinates, which are pixel coordinates from which the influence of camera parameters is removed, based on the camera parameters of the imaging device 20. At this time, the image corrector 600 converts the correction coordinates into intermediate coordinates according to Equation 4 below.

$$[ \begin{matrix}{x}_{m} \\ {y}_{m} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{r} \\ {y}_{r} \\ 1\end{matrix} ] \qquad [ Equation 4 ]$$

In Equation 4, (xₘ, yₘ) represents the intermediate coordinates, and (xᵣ, yᵣ) represents the correction coordinates. In addition, (fₓ, f_{y}) is the focal length among the camera parameters, (cₓ, c_{y}) is the coordinates of the lens center among the camera parameters, and skew represents the asymmetry coefficient among the camera parameters.

Next, in step S620, the image corrector 600 calculates the distance to the center of the intermediate coordinates. At this time, the distance to the center is derived according to Equation 5 below.

$${r}_{c}^{2} = {x}_{m}^{2} + {y}_{m}^{2} \qquad [ Equation 5 ]$$

In Equation 5, (xₘ, yₘ) is the intermediate coordinates, and r_{c} represents the distance to the center of the intermediate coordinates.

Then, in step S630, the image corrector 600 applies the aberration distortion caused by the camera lens to the intermediate coordinates and thereby derives the distortion coordinates. At this time, the distortion coordinates can be derived according to Equation 6 below.

$$[ \begin{matrix}{x}_{d} \\ {y}_{d}\end{matrix} ] = ( 1 + {k}_{1} {r}_{c}^{2} + {k}_{2} {r}_{c}^{4} + {k}_{3} {r}_{c}^{6} ) [ \begin{matrix}{x}_{m} \\ {y}_{m}\end{matrix} ] + [ \begin{matrix}2 {P}_{1} {x}_{m} {y}_{m} + {P}_{2} ( {r}_{c}^{2} + 2 {x}_{m}^{2} ) \\ {P}_{1} ( {r}_{c}^{2} + 2 {y}_{m}^{2} ) + 2 {P}_{2} {x}_{m} {y}_{m}\end{matrix} ] \qquad [ Equation 6 ]$$

In Equation 6, (x_{d}, y_{d}) represents the distortion coordinates, which are the distorted pixel coordinates due to the lens aberration. In addition, (xₘ, yₘ) is the intermediate coordinates, and r_{c} represents the distance to the center of the intermediate coordinates. In Equation 6, the first term represents the radial distortion, and the second term represents the tangential distortion. k₁, k₂ and k₃ represent the radial distortion coefficients, and P₁ and P₂ represent the tangential distortion coefficients.

Next, in step S640, the image corrector 600 applies the camera parameters to the distortion coordinates and thereby derives the oblique coordinates, which are the pixel coordinates of the oblique image. At this time, the oblique coordinates can be derived according to Equation 7 below.

$$[ \begin{matrix}{x}_{g} \\ {y}_{g} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{d} \\ {y}_{d} \\ 1\end{matrix} ] \qquad [ Equation 7 ]$$

In Equation 7, (x_{g}, y_{g}) represents the oblique coordinates, and (x_{d}, y_{d}) represents the distortion coordinates, which are pixel coordinates distorted by lens aberration. In addition, (fₓ, f_{y}) is the focal length among the camera parameters, (cₓ, c_{y}) is the coordinates of the lens center among the camera parameters, and skew represents the asymmetry coefficient among the camera parameters.

Then, in step S650, the image corrector 600 can generate the corrected image by configuring the pixel values of the oblique coordinates derived in response to the correction coordinates into the pixel values of the correction coordinates.

### Hardware System

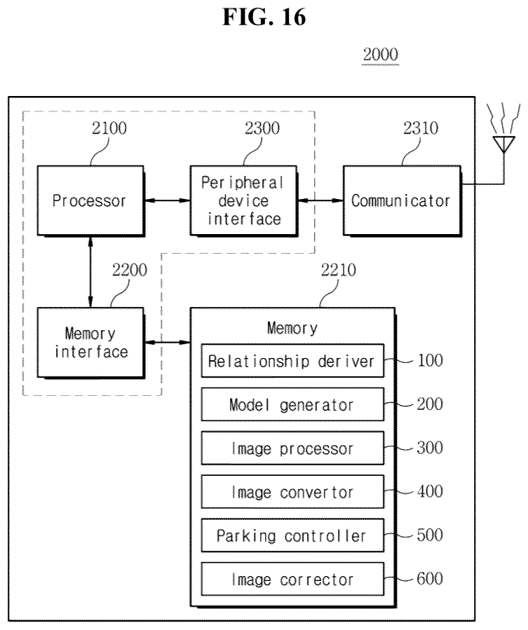

The above-described apparatuses for parking management according to the first and second embodiments of the present disclosure can be implemented as a hardware system. FIG. 16 is a diagram illustrating a hardware system for implementing the apparatus according to the first and second embodiments of the present disclosure.

As shown in FIG. 16, the hardware system 2000 may include a processor 2100, a memory interface 2200, and a peripheral device interface 2300.

These respective elements in the hardware system 2000 may be individual components or be integrated into one or more integrated circuits and may be connected by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, components such as the relationship deriver 100, the model generator 200, the image processor 300, the image convertor 400, the parking controller 500, and/or the image corrector 600 described above in FIGS. 3 and 11 may be stored in the form of software modules, and the operating system (OS) may be further stored. These components may be loaded into and executed by the processor 2100.

In addition, the above-mentioned components may be implemented in the form of a software module or hardware module executed by the processor 2100, or may also be implemented in the form of a combination of a software module and a hardware module. As such, the software module, the hardware module, or the combination thereof executed by the processor may be implemented as an actual hardware system (e.g., a computer system).

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices. The peripheral devices are to provide different functions to the hardware system 2000, and may include a communicator 2310 for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to the present disclosure, each components stored in the memory 2210 in the form of a software module performs an interface with the communicator 2310 via the memory interface 2200 and the peripheral device interface 2300 in the form of a command executed by the processor 2100.

While the description contains many specific implementation details, these should not be construed as limitations on the scope of the present disclosure or of what may be claimed, but rather as descriptions of features that may be specific to particular embodiments of particular disclosure.

Also, although the description describes that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

The description shows the best mode of the present disclosure and provides examples to illustrate the present disclosure and to enable a person skilled in the art to make and use the present disclosure. The present disclosure is not limited by the specific terms used herein. Based on the above-described embodiments, one of ordinary skill in the art can modify, alter, or change the embodiments without departing from the scope of the present disclosure.

Accordingly, the scope of the present disclosure should not be limited by the described embodiments and should be defined by the appended claims.

What is claimed is:

1. A method for parking management, the method comprising:
by an image processor, receiving a plurality of streaming images of a parking lot taken by a plurality of imaging devices arranged at different locations in a direction forming a predetermined angle with a parking lot floor;
by the image processor, extracting frames from each of the plurality of streaming images at regular intervals to generate a plurality of oblique images and then generating a plurality of oblique image groups arranged in time order from the generated plurality of oblique images;
by an image convertor, generating a plurality of planar images arranged in time order by processing the plurality of oblique image groups;
by a parking controller, detecting bounding boxes of a parking space and of a vehicle from the plurality of planar images arranged in time order through a detection model; and
by the parking controller, determining whether the vehicle is parked or not in the parking space, based on a change in a degree of overlap between the bounding box of the parking space and the bounding box of the vehicle detected in time order.

2. The method of claim 1, further comprising:
before receiving the plurality of streaming images,
by a relationship deriver, preparing a training planar image which is a target planar image;
by the relationship deriver, collecting a plurality of training streaming images from the plurality of imaging devices;
by the relationship deriver, extracting a plurality of training oblique images from the plurality of training streaming images; and
by the relationship deriver, deriving a homography corresponding to each of the plurality of training oblique images by comparing each of the plurality of training oblique images with the training planar image.

3. The method of claim 2, wherein when a matrix representing a homography, hᵢⱼ (i≤1, j≤3), satisfies Equation 1, the relationship deriver derives the matrix that minimizes Equation 2 as the homography,
$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 1 ]$$
$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 2 ]$$
where (xᵢ, yᵢ) represents coordinates of the training oblique image, and (xᵢ′, yᵢ′) represents coordinates of the training planar image.

4. The method of claim 2, wherein generating the plurality of planar images includes:
by the image convertor, generating a plurality of planar slice images by applying the homography to the plurality of oblique images; and
by the image convertor, generating the planar image by aligning the plurality of planar slice images.

5. The method of claim 1, wherein determining whether the vehicle is parked or not includes:
by the parking controller, calculating an intersection over union (IOU) between the bounding boxes of the parking space and of the vehicle from the plurality of planar images arranged in time order; and
by the parking controller, determining that the vehicle is parked in the parking space if the calculated IOU increases in time sequence and then remains unchanged, or determining that the vehicle exits the parking space if the calculated IOU decreases and then becomes zero.

6. The method of claim 5, wherein in case where the vehicle is parked, the parking controller performs:
calculating a reference value indicating a ratio of the bounding box of the parking space to the bounding box of the vehicle;
if the IOU is smaller than the reference value, determining that a parking status of the vehicle is incorrect; and
transmitting a guidance broadcast to guide the vehicle to correctly park while keeping to a parking line.

7. The method of claim 1, wherein generating the plurality of oblique image groups includes:
by the image processor, extracting frames from the plurality of streaming images at regular intervals and thereby generating the plurality of oblique images;
by the image processor, generating the plurality of oblique image groups by grouping oblique images having a same time stamp from among the plurality of oblique images; and
by the image processor, arranging the plurality of oblique image groups in time order of time stamps.

8. The method of claim 1, further comprising:
before receiving the plurality of streaming images,
by a model generator, preparing learning data that includes a planar image and a label corresponding to the planar image, wherein the planar image contains a vehicle and a parking space, and the label is a ground-truth box indicating an area occupied by each of the vehicle and the parking space in the planar image;
by the model generator, inputting the planar image into an untrained detection model;
by the detection model, performing a plurality of operations in which untrained inter-layer weights are applied to the planar image, and thereby detecting a bounding box indicating an area occupied by each of the vehicle and the parking space in the planar image;
by the model generator, calculating a loss indicating a difference between the detected bounding box and the ground-truth box; and
by the model generator, performing optimization to modify the weights of the detection model so that the calculated loss is minimized.

9. An apparatus for parking management, the apparatus comprising:
an image processor configured to receive a plurality of streaming images of a parking lot taken by a plurality of imaging devices arranged at different locations in a direction forming a predetermined angle with a parking lot floor, to extract frames from each of the plurality of streaming images at regular intervals to generate a plurality of oblique images, and to generate a plurality of oblique image groups arranged in time order from the generated plurality of oblique images;
an image convertor configured to generate a plurality of planar images arranged in time order by processing the plurality of oblique image groups; and
a parking controller configured to detect bounding boxes of a parking space and of a vehicle from the plurality of planar images arranged in time order through a detection model, and to determine whether the vehicle is parked or not in the parking space, based on a change in a degree of overlap between the bounding box of the parking space and the bounding box of the vehicle detected in time order.

10. The apparatus of claim 9, further comprising:
a relationship deriver configured to:
prepare a training planar image which is a target planar image,
collect a plurality of training streaming images from the plurality of imaging devices,
extract a plurality of training oblique images from the plurality of training streaming images, and
derive a homography corresponding to each of the plurality of training oblique images by comparing each of the plurality of training oblique images with the training planar image.

11. The apparatus of claim 10, wherein when a matrix representing a homography, hᵢⱼ (i≤1, j≤3), satisfies Equation 1, the relationship deriver derives the matrix that minimizes Equation 2 as the homography,
$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 1 ]$$
$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 2 ]$$
where (xᵢ, yᵢ) represents coordinates of the training oblique image, and (xᵢ′, yᵢ′) represents coordinates of the training planar image.

12. The apparatus of claim 10, wherein the image convertor is configured to:
generate a plurality of planar slice images by applying the homography to the plurality of oblique images, and
generate the planar image by aligning the plurality of planar slice images.

13. The apparatus of claim 9, wherein the parking controller is configured to:
calculate an intersection over union (IOU) between the bounding boxes of the parking space and of the vehicle from the plurality of planar images arranged in time order, and
determine that the vehicle is parked in the parking space if the calculated IOU increases in time sequence and then remains unchanged, or determine that the vehicle exits the parking space if the calculated IOU decreases and then becomes zero.

14. The apparatus of claim 13, wherein the parking controller is configured to:
upon determining that the vehicle is parked in the parking space,
calculate a reference value indicating a ratio of the bounding box of the parking space to the bounding box of the vehicle,
if the IOU is smaller than the reference value, determine that a parking status of the vehicle is incorrect, and
transmit a guidance broadcast to guide the vehicle to correctly park while keeping to a parking line.

15. The apparatus of claim 9, wherein the image processor is configured to:
extract frames from the plurality of streaming images at regular intervals and thereby generate the plurality of oblique images,
generate the plurality of oblique image groups by grouping oblique images having a same time stamp from among the plurality of oblique images, and
arrange the plurality of oblique image groups in time order of time stamps.

16. The apparatus of claim 9, further comprising:
a model generator configured to:
prepare learning data that includes a planar image and a label corresponding to the planar image, wherein the planar image contains a vehicle and a parking space, and the label is a ground-truth box indicating an area occupied by each of the vehicle and the parking space in the planar image,
input the planar image into an untrained detection model,
perform a plurality of operations in which untrained inter-layer weights are applied to the planar image, and thereby detecting a bounding box indicating an area occupied by each of the vehicle and the parking space in the planar image,
calculate a loss indicating a difference between the detected bounding box and the ground-truth box, and
perform optimization to modify the weights of the detection model so that the calculated loss is minimized.

17. A method for parking management, the method comprising:
by an image processor, receiving a streaming image of a parking lot taken by an imaging device in a direction forming a predetermined angle with a parking lot floor;
by the image processor, generating a plurality of oblique images by extracting frames from the streaming image at regular intervals;
by an image corrector, generating a plurality of corrected images arranged in time order by correcting distortion caused by aberration of a camera lens of the imaging device for the plurality of oblique images;
by a parking controller, detecting bounding boxes of a parking space and of a vehicle from the plurality of arranged corrected images through a detection model; and
by the parking controller, determining whether the vehicle is parked or not in the parking space, by analyzing a change in a degree of overlap between the bounding box of the parking space and the bounding box of the vehicle according to time sequence.

18. The method of claim 17, wherein generating the plurality of corrected images includes:
by the image corrector, converting correction coordinates, which are pixel coordinates of the corrected image, into intermediate coordinates, which are pixel coordinates from which influence of camera parameters is removed, based on the camera parameters of the imaging device;
by the image corrector, calculating a distance to a center of the intermediate coordinate;
by the image corrector, deriving distortion coordinates by applying the distortion caused by the aberration of the camera lens of the imaging device to the intermediate coordinates, based on the calculated distance to the center;
by the image corrector, deriving oblique coordinates, which are pixel coordinates of the oblique image, by applying the camera parameters to the distortion coordinates; and
by the image corrector, generating the corrected image by configuring pixel values of the oblique coordinates derived in response to the correction coordinates into pixel values of the correction coordinates.

19. The method of claim 18, wherein upon converting into the intermediate coordinates, the image corrector derives the intermediate coordinates according to Equation,
$$[ \begin{matrix}{x}_{m} \\ {y}_{m} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{r} \\ {y}_{r} \\ 1\end{matrix} ]$$
where (xₘ, yₘ) represents the intermediate coordinates, (xᵣ, yᵣ) represents the correction coordinates, (fₓ, f_{y}) is the focal length among the camera parameters, (cₓ, c_{y}) is the coordinates of the lens center among the camera parameters, and skew represents the asymmetry coefficient among the camera parameters.

20. The method of claim 18, wherein upon calculating the distance to the center, the image corrector calculates the distance to the center according to Equation,
$${r}_{c}^{2} = {x}_{m}^{2} + {y}_{m}^{2}$$
where (xₘ, yₘ) is the intermediate coordinates, and r_{c} represents the distance to the center of the intermediate coordinates.

21. The method of claim 18, wherein upon deriving the oblique coordinates, the image corrector drives the distortion coordinates according to Equation,
$$[ \begin{matrix}{x}_{d} \\ {y}_{d}\end{matrix} ] = ( 1 + {k}_{1} {r}_{c}^{2} + {k}_{2} {r}_{c}^{4} + {k}_{3} {r}_{c}^{6} ) [ \begin{matrix}{x}_{m} \\ {y}_{m}\end{matrix} ] + [ \begin{matrix}2 {P}_{1} {x}_{m} {y}_{m} + {P}_{2} ( {r}_{c}^{2} + 2 {x}_{m}^{2} ) \\ {P}_{1} ( {r}_{c}^{2} + 2 {y}_{m}^{2} ) + 2 {P}_{2} {x}_{m} {y}_{m}\end{matrix} ]$$
where (x_{d}, y_{d}) represents the distortion coordinates, which are distorted pixel coordinates due to the lens aberration, (xₘ, yₘ) is the intermediate coordinates, r_{c} represents the distance to the center of the intermediate coordinates, k₁, k₂ and k₃ represent radial distortion coefficients, and P₁ and P₂ represent tangential distortion coefficients.

22. The method of claim 18, wherein upon deriving the oblique coordinates, the image corrector derives the oblique coordinates according to Equation,
$$[ \begin{matrix}{x}_{g} \\ {y}_{g} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{d} \\ {y}_{d} \\ 1\end{matrix} ]$$
where (x_{g}, y_{g}) represents the oblique coordinates, (x_{d}, y_{d}) represents the distortion coordinates, which are pixel coordinates distorted by lens aberration, (fₓ, f_{y}) is the focal length among the camera parameters, (cₓ, c_{y}) is the coordinates of the lens center among the camera parameters, and skew represents the asymmetry coefficient among the camera parameters.

23. The method of claim 17, wherein determining whether the vehicle is parked or not includes:
by the parking controller, calculating an intersection over union (IOU) between the bounding boxes of the parking space and of the vehicle from the plurality of corrected images; and
by the parking controller, determining that the vehicle is parked in the parking space if the calculated IOU increases and then remains unchanged, or determining that the vehicle exits the parking space if the calculated IOU decreases and then becomes zero.

24. The method of claim 23, wherein in case where the vehicle is parked, the parking controller performs:
calculating a reference value indicating a ratio of the bounding box of the parking space to the bounding box of the vehicle;
if the IOU is smaller than the reference value, determining that a parking status of the vehicle is incorrect; and
transmitting a guidance broadcast to guide the vehicle to correctly park while keeping to a parking line.

25. The method of claim 17, further comprising:
before receiving the plurality of streaming images,
by a model generator, preparing learning data that includes a corrected image and a label corresponding to the corrected image, wherein the corrected image contains a vehicle and a parking space, and the label is a ground-truth box indicating an area occupied by each of the vehicle and the parking space in the corrected image;
by the model generator, inputting the corrected image into an untrained detection model;
by the detection model, performing a plurality of operations in which untrained inter-layer weights are applied to the corrected image, and thereby detecting a bounding box indicating an area occupied by each of the vehicle and the parking space in the corrected image;
by the model generator, calculating a loss indicating a difference between the detected bounding box and the ground-truth box; and
by the model generator, performing optimization to modify the weights of the detection model so that the calculated loss is minimized.

26. An apparatus for parking management, the apparatus comprising:
an image processor configured to receive a streaming image of a parking lot taken by an imaging device in a direction forming a predetermined angle with a parking lot floor, and to generate a plurality of oblique images by extracting frames from the streaming image at regular intervals;
an image corrector configured to generate a plurality of corrected images arranged in time order by correcting distortion caused by aberration of a camera lens of the imaging device for the plurality of oblique images; and
a parking controller configured to detect bounding boxes of a parking space and of a vehicle from the plurality of arranged corrected images through a detection model, and to determine whether the vehicle is parked or not in the parking space, by analyzing a change in a degree of overlap between the bounding box of the parking space and the bounding box of the vehicle according to time sequence.

27. The apparatus of claim 26, wherein the image corrector is configured to:
convert correction coordinates, which are pixel coordinates of the corrected image, into intermediate coordinates, which are pixel coordinates from which influence of camera parameters is removed, based on the camera parameters of the imaging device, calculate a distance to a center of the intermediate coordinate,
derive distortion coordinates by applying the distortion caused by the aberration of the
camera lens of the imaging device to the intermediate coordinates, based on the calculated distance to the center,
derive oblique coordinates, which are pixel coordinates of the oblique image, by applying the camera parameters to the distortion coordinates, and
generate the corrected image by configuring pixel values of the oblique coordinates derived in response to the correction coordinates into pixel values of the correction coordinates.

28. The apparatus of claim 27, wherein the image corrector derives the intermediate coordinates according to Equation,
$$[ \begin{matrix}{x}_{m} \\ {y}_{m} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{r} \\ {y}_{r} \\ 1\end{matrix} ]$$
where (xₘ, yₘ) represents the intermediate coordinates, (xᵣ, yᵣ) represents the correction coordinates, (fₓ, f_{y}) is the focal length among the camera parameters, (cₓ, c_{y}) is the coordinates of the lens center among the camera parameters, and skew represents the asymmetry coefficient among the camera parameters.

29. The apparatus of claim 27, wherein the image corrector calculates the distance to the center according to Equation,
$${r}_{c}^{2} = {x}_{m}^{2} + {y}_{m}^{2}$$
where (xₘ, yₘ) is the intermediate coordinates, and r_{c} represents the distance to the center of the intermediate coordinates.

30. The apparatus of claim 27, wherein the image corrector drives the distortion coordinates according to Equation,
$$[ \begin{matrix}{x}_{d} \\ {y}_{d}\end{matrix} ] = ( 1 + {k}_{1} {r}_{c}^{2} + {k}_{2} {r}_{c}^{4} + {k}_{3} {r}_{c}^{6} ) [ \begin{matrix}{x}_{m} \\ {y}_{m}\end{matrix} ] + [ \begin{matrix}2 {P}_{1} {x}_{m} {y}_{m} + {P}_{2} ( {r}_{c}^{2} + 2 {x}_{m}^{2} ) \\ {P}_{1} ( {r}_{c}^{2} + 2 {y}_{m}^{2} ) + 2 {P}_{2} {x}_{m} {y}_{m}\end{matrix} ]$$
where (x_{d}, y_{d}) represents the distortion coordinates, which are distorted pixel coordinates due to the lens aberration, (xₘ, yₘ) is the intermediate coordinates, r_{c} represents the distance to the center of the intermediate coordinates, k₁, k₂ and k₃ represent radial distortion coefficients, and P₁ and P₂ represent tangential distortion coefficients.

31. The apparatus of claim 27, wherein the image corrector derives the oblique coordinates according to Equation,
$$[ \begin{matrix}{x}_{g} \\ {y}_{g} \\ 1\end{matrix} ] = [ \begin{matrix}{f}_{x} & skew \cdot {f}_{x} & {c}_{x} \\ 0 & {f}_{y} & {c}_{y} \\ 0 & 0 & 1\end{matrix} ] [ \begin{matrix}{x}_{d} \\ {y}_{d} \\ 1\end{matrix} ]$$
where (x_{g}, y_{g}) represents the oblique coordinates, (x_{d}, y_{d}) represents the distortion coordinates, which are pixel coordinates distorted by lens aberration, (fₓ, f_{y}) is the focal length among the camera parameters, (cₓ, c_{y}) is the coordinates of the lens center among the camera parameters, and skew represents the asymmetry coefficient among the camera parameters.

32. The apparatus of claim 26, wherein the parking controller is configured to:
calculate an intersection over union (IOU) between the bounding boxes of the parking space and of the vehicle from the plurality of corrected images, and
determine that the vehicle is parked in the parking space if the calculated IOU increases and then remains unchanged, or determine that the vehicle exits the parking space if the calculated IOU decreases and then becomes zero.

33. The apparatus of claim 32, wherein the parking controller is configured to:
upon determining that the vehicle is parked in the parking space,
calculate a reference value indicating a ratio of the bounding box of the parking space to the bounding box of the vehicle,
if the IOU is smaller than the reference value, determine that a parking status of the vehicle is incorrect, and
transmit a guidance broadcast to guide the vehicle to correctly park while keeping to a parking line.

34. The apparatus of claim 26, further comprising:
a model generator configured to:
prepare learning data that includes a corrected image and a label corresponding to the corrected image, wherein the corrected image contains a vehicle and a parking space, and the label is a ground-truth box indicating an area occupied by each of the vehicle and the parking space in the corrected image,
input the corrected image into an untrained detection model,
perform a plurality of operations in which untrained inter-layer weights are applied to the corrected image, and thereby detecting a bounding box indicating an area occupied by each of the vehicle and the parking space in the corrected image,
calculate a loss indicating a difference between the detected bounding box and the ground-truth box, and
perform optimization to modify the weights of the detection model so that the calculated loss is minimized.
